(19) United States
(12) Patent Application Publication
(10) Pub. No.: US 2026/0267513 A1
(43) Pub. Date: Sep. 10, 2026

(54) STORAGE DEVICE STORING ARTIFICIAL INTELLIGENCE MODEL, AND OPERATING METHOD THEREOF

(71) Applicant: SK hynix Inc., Gyeonggi-do (KR)

(72) Inventors: Byoung Min JIN, Gyeonggi-do (KR); Ku Ik KWON, Gyeonggi-do (KR); Gyu Yeul HONG, Gyeonggi-do (KR)

(21) Appl. No.: 19/291,625

(22) Filed: Aug. 6, 2025

(30) Foreign Application Priority Data
Mar. 10, 2025 (KR) 10-2025-0030758

(51) Int. Cl. G06F 3/06

(52) U.S. Cl. CPC G06F 3/0611; G06F 3/0659; G06F 3/0673

(57) ABSTRACT

A storage device may include a memory configured to store a plurality of data units, each data unit including at least one of parameters of an artificial intelligence model; and a controller configured to externally receive structure information on the artificial intelligence model, determine the plurality of data units based on the structure information, and determine whether to cache each of the plurality of data units in a cache.

### CROSS-REFERENCE TO RELATED APPLICATION

The present application claims priority under 35 U.S.C. §119(a) to Korean Patent Application No. 10-2025-0030758 filed on Mar. 10, 2025, which is incorporated herein by reference in its entirety.

### BACKGROUND

### 1. Technical Field

Embodiments of the present disclosure relate to a storage device for storing an artificial intelligence model, and an operating method thereof.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

The storage device may store an artificial intelligence model. In order to improve the performance of artificial intelligence, it is necessary to shorten the time required to read the artificial intelligence model stored in the storage device. In particular, when a plurality of processors perform operations of reading in parallel the artificial intelligence model stored in the storage device, it is necessary to improve read performance by shortening the time required for the read operations.

### SUMMARY

Embodiments of the present disclosure are directed to providing a storage device and a method of operating the same capable of improving read performance on an artificial intelligence model stored in the storage device.

Advantages of the embodiments of the present disclosure are not limited to those set forth herein, and other unmentioned advantages would be apparent to one of ordinary skill in the art from the following description.

In an embodiment of the present disclosure, a storage device may include a memory configured to store a plurality of data units, each data unit including at least one of parameters of an artificial intelligence model; and a controller configured to externally receive structure information on the artificial intelligence model, determine the plurality of data units based on the structure information, and determine whether to cache each of the plurality of data units in a cache.

In an embodiment of the present disclosure, a method of operating a storage device including a memory may include externally receiving structure information about an artificial intelligence model; determining a plurality of data units based on the structure information, each data unit including at least one of parameters of the artificial intelligence model; storing the plurality of data units in the memory; and determining whether to cache each of the plurality of data units in a cache.

According to the embodiments of the present disclosure, it is possible to provide a storage device and a method of operating the same capable of improving read performance on an artificial intelligence model stored in the storage device.

The advantages of the present disclosure are not limited to the foregoing advantages, and other advantages will be apparent to one of ordinary skill in the art from the following detailed description.

### BRIEF DESCRIPTION OF THE DRAWINGS

The embodiments of the present disclosure will be more fully understood from the following detailed description and the accompanying drawings, which are provided for illustration only and are not intended to limit the embodiments.

FIG. 1 is a block diagram illustrating a configuration of a storage device according to an embodiment of the present disclosure.

FIG. 2 is a block diagram illustrating a detailed configuration of a memory of FIG. 1, according to an embodiment of the present disclosure.

FIG. 3 is a diagram for describing an operation of the storage device according to an embodiment of the present disclosure.

FIG. 4 is a diagram illustrating structure information on an artificial intelligence model, according to an embodiment of the present disclosure.

FIG. 5 is a diagram for describing an operation of the storage device that determines a plurality of data units, according to an embodiment of the present disclosure.

FIG. 6 is a diagram illustrating a structure of the plurality of data units, according to an embodiment of the present disclosure.

FIG. 7 is a flowchart for describing an operation of the storage device that determines whether to cache a first data unit in a cache, according to an embodiment of the present disclosure.

FIG. 8 is a diagram for describing an operation of the storage device that caches a data unit in the cache, according to an embodiment of the present disclosure.

FIG. 9 is a diagram for describing an operation of the storage device that caches data units in the cache, according to an embodiment of the present disclosure.

FIG. 10 is a diagram for describing an operation of the storage device that evicts a data unit from the cache, according to an embodiment of the present disclosure.

FIG. 11 is a flowchart for describing a method of operating a storage device according to an embodiment of the present disclosure.

### DETAILED DESCRIPTION

Hereinafter, embodiments of the present disclosure are described in detail with reference to the accompanying drawings. In assigning reference numerals to components of each drawing, the same components may be assigned the same numerals even when they are shown on different drawings. When it is determined that details of the known art or functions make the subject matter of the present disclosure unclear, the details of the known art or functions may be skipped. As used herein, when a component “includes,” “has,” or “is composed of” another component, the component may add other components unless the terms “only includes”, “only has”, or “only is composed of” the other component are used when referencing the other component. As used herein, the singular forms “a”, “an” and “the” are intended to include the plural forms as well, unless the context clearly indicates otherwise.

Labels such as "first," "second," "A," "B," "(a)," and "(b)," may be used in describing the components of the present disclosure. These labels are provided merely to distinguish a component from another, and the essence, order, or number of the components are not limited by the labels.

In describing the positional relationship between components, when two or more components are described as "connected", "coupled" or "linked", the two or more components may be directly "connected", "coupled" or "linked" ", or another component may intervene. Here, the other component may be included in one or more of the two or more components that are “connected”, “coupled” or “linked” to each other.

When such terms as, e.g., “after”, “next to”, “after”, and “before”, are used to describe the temporal flow relationship related to components, operation methods, and fabricating methods, it may include a non-continuous relationship unless the term “immediately” or “directly” is used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the present disclosure are described in detail with reference to the accompanying drawings.

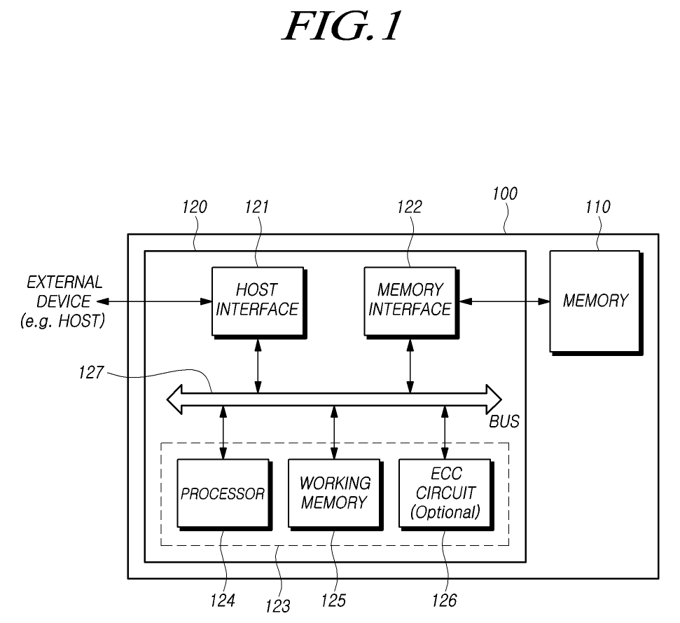

FIG. 1 is a block diagram illustrating a configuration diagram of a storage device 100 according to an embodiment of the present disclosure.

Referring to FIG. 1, the storage device 100 may include a memory 110 that stores data and a controller 120 that controls the memory 110.

The memory 110 includes a plurality of memory blocks, and operates in response to the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized as various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the present disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. That is, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various communication standards or interfaces such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, an operation of the storage device 100 according to embodiments of the present disclosure will be described as implementing a processor 124 that executes firmware in which the corresponding operation is defined.

Firmware is a program to be executed in the storage device 100 to drive the storage device 100, and may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata is data for managing the memory 110, and may include, for example, management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Moreover, the controller 120 may additionally use a separate volatile memory (e.g. SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be removed, or some components among the above-described components 121, 122, 124, 125 and 126 of the controller 120 may be integrated into one component. In addition to the above-described components 121, 122, 124, 125 and 126 of the controller 120, one or more other components may be added.

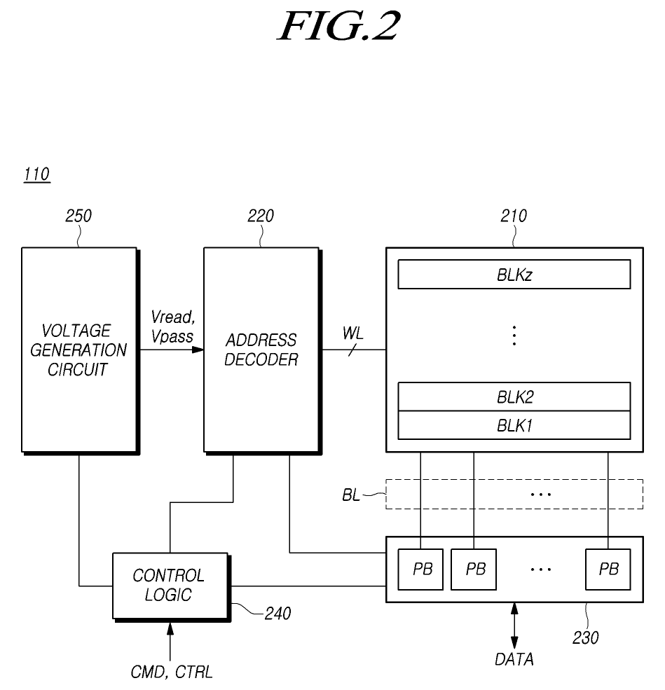

Hereinbelow, the memory 110 will be described in further detail with reference to FIG. 2.

FIG. 2 is a block diagram illustrating a detailed configuration of a memory 110 of FIG. 1, according to an embodiment of the present disclosure.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz, where z is a natural number of 2 or greater.

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. In an embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

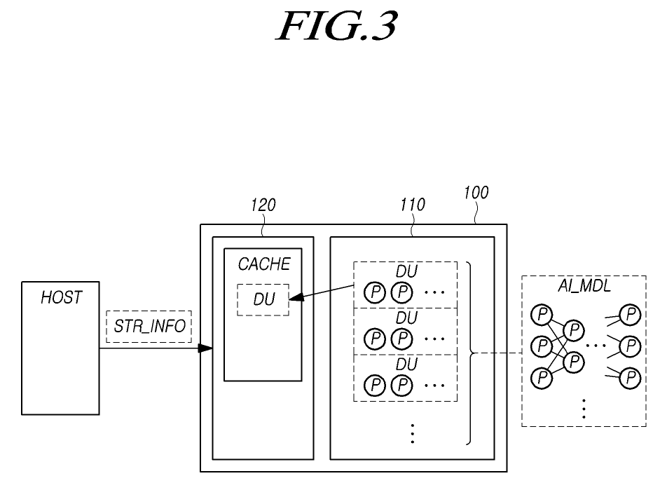

FIG. 3 is a diagram for describing an operation of the storage device 100 according to an embodiment of the present disclosure.

Referring to FIG. 3, the storage device 100 may include the memory 110 and the controller 120.

The memory 110 may store a plurality of data units DU. Each of the plurality of data units DU may include at least one of parameters P of an artificial intelligence model AI_MDL.

The artificial intelligence model AI_MDL may analyze inputted data and output an inference result for the inputted data. The artificial intelligence model AI_MDL may include one or more layers (e.g., an input layer, a hidden layer and an output layer) that are used to compute the inference result from the inputted data. The parameters P of the artificial intelligence model AI_MDL may be disposed in one or more layers.

The artificial intelligence models AI_MDL may be learned through learning data. Performing learning on the artificial intelligence model AI_MDL means adjusting the parameters of the artificial intelligence model AI_MDL so that an output for an input to the artificial intelligence model AI_MDL is as similar as possible to a ground-truth.

Moreover, the learning process of the artificial intelligence model AI_MDL may be expressed as training, and the result thereof may be expressed as learning, but either training or learning may be used to express the learning process or the result thereof.

The artificial intelligence models AI_MDL may be implemented in various ways. For example, the artificial intelligence model AI_MDL may be a current or future machine learning model, such as a model that performs algorithm-based machine learning (e.g., a tree-based model), k-Nearest Neighbors, k-Means Clustering, Principal Component Analysis (PCA), a support vector machine (SVM) or a model that performs artificial neural network-based learning (e.g., CNN or RNN).

The artificial intelligence model AI_MDL may be stored as a checkpoint during a training process and may be stored in the form of an archive in the memory 110 during an inference process. The artificial intelligence model AI_MDL may be sequentially stored in the memory 110.

The parameters included in the artificial intelligence model AI_MDL may be processed by a plurality of processors, and may be processed simultaneously or at similar time frames. In the learning and inference operations of the artificial intelligence model AI_MDL, an operation is performed in which the plurality of processors refers to and computes the parameters of the artificial intelligence model AI_MDL, and to this end, the storage device 100 may process a plurality of read requests for the artificial intelligence model AI_MDL.

Because the plurality of processors each read the parameters they use from the artificial intelligence model AI_MDL, a workload for the artificial intelligence model AI_MDL may have the characteristics of random read.

The controller 120 may receive structure information STR_INFO on the artificial intelligence model AI_MDL from the outside (e.g., the host HOST) of the storage device 100.

In embodiments of the present disclosure, the structure information STR_INFO may be determined in various forms. For example, the structure information STR_INFO may include direct information on the plurality of data units DU (e.g., the number of the plurality of data units DU, the size of each of the plurality of data units DU and a logical address area corresponding to each of the plurality of data units DU). For another example, the structure information STR_INFO may include characteristic information used by the controller 120 to determine the structure of the plurality of data units DU.

The controller 120 may determine the plurality of data units DU based on the received structure information STR_INFO. The controller 120 may determine a structure in which the parameters P of the artificial intelligence model AI_MDL are stored in the memory 110, based on the structure information STR_INFO.

The controller 120 may determine whether to cache each of the plurality of data units DU in a cache CACHE.

The cache CACHE is a volatile memory capable of caching the plurality of data units DU, and a data unit cached in the cache CACHE may be read faster than the data units stored in the memory 110.

In embodiments of the present disclosure, the cache CACHE may be implemented in various ways. For example, the cache CACHE may be the working memory 125 included in the controller 120.

FIG. 3 illustrates a case where the cache CACHE is included in the controller 120, but the cache CACHE may be implemented as a separate volatile memory or nonvolatile memory located outside the controller 120.

The controller 120 may independently determine, for each of the plurality of data units DU, whether to cache each of the plurality of data units DU in the cache CACHE. That is, the controller 120 may determine whether to cache one data unit of the plurality of data units DU in the cache CACHE, regardless of whether other data units are cached in the cache CACHE.

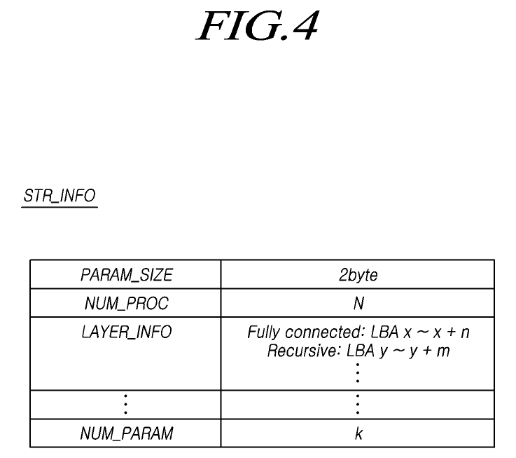

FIG. 4 is a diagram illustrating the structure information STR_INFO on the artificial intelligence model AI_MDL, according to an embodiment of the present disclosure.

In embodiments of the present disclosure, the structure information STR_INFO may include at least one of the number NUM_PROC of processors that access the artificial intelligence model AI_MDL in parallel, the number NUM_PARAM of parameters of the artificial intelligence model AI_MDL, the size PARAM_SIZE of each parameter of the artificial intelligence model AI_MDL, and layer information LAYER_INFO of the artificial intelligence model AI_MDL. The layer information LAYER_INFO of the artificial intelligence model AI_MDL may include the information of a logical address area corresponding to each of the layers included in the artificial intelligence model AI_MDL.

In FIG. 4, the number NUM_PROC of processors that access the artificial intelligence model AI_MDL in parallel is N, the size PARAM_SIZE of each parameter of the artificial intelligence model AI_MDL is 2 bytes, and the number NUM_PARAM of parameters of the artificial intelligence model AI_MDL is k. The layer information LAYER_INFO of the artificial intelligence model AI_MDL indicates that data corresponding to a logical address area x to x+n corresponds to a fully connected layer and data corresponding to a logical address area y to y+m corresponds to a recursive layer.

The controller 120 of the storage device 100 may configure the plurality of data units DU based on the structure information STR_INFO. The controller 120 may predict expected operations in which processors (e.g., the host HOST) outside the storage device 100 access the parameters of the artificial intelligence model AI_MDL, based on the structure information STR_INFO, and may configure the plurality of data units DU based on this.

For example, the controller 120 may determine the number of the plurality of data units DU to be proportional to the number NUM_PROC of processors.

In another embodiment, the controller 120 may determine the number of the plurality of data units DU to be proportional to the product of the size PARAM_SIZE of each parameter of the artificial intelligence model AI_MDL and the number NUM_PARAM of parameters of the artificial intelligence model AI_MDL.

In another embodiment, the controller 120 may determine the size of each of the plurality of data units DU based on the size of the logical address area of each of the layers included in the layer information LAYER_INFO of the artificial intelligence model AI_MDL.

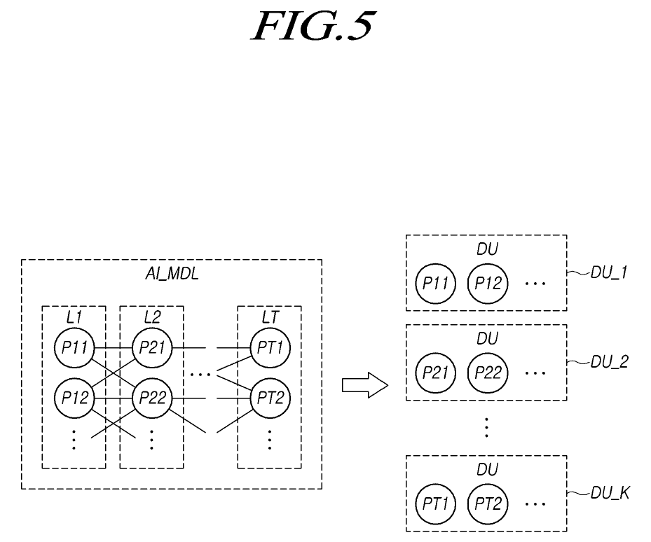

FIG. 5 is a diagram for describing an operation of the storage device 100 that determines the plurality of data units DU, according to an embodiment of the present disclosure.

Referring to FIG. 5, the artificial intelligence model AI_MDL may include T number of layers L1, L2, …, LT, where T is a natural number.

Each of the T number of layers L1, L2, …, LT may include one or more parameters. In FIG. 5, the layer L1 may include parameters P11, P12, …, the layer L2 may include parameters P21, P22, …, and the layer LT may include parameters PT1, PT2, ….

The controller 120 of the storage device 100 may determine the structure of the plurality of data units DU corresponding to the artificial intelligence model AI_MDL as follows.

For example, parameters included in each of the plurality of data units DU may be parameters included in a specific one layer among the T number of layers L1, L2, ..., LT included in the artificial intelligence model AI_MDL.

In this case, all parameters included in one data unit DU may be included in the same layer. Parameters included in one layer may be stored in at least one of the plurality of data units DU.

Through this, when receiving a read command for a specific layer of the artificial intelligence model AI_MDL from the outside (e.g., the host HOST) of the storage device 100, the controller 120 may minimize the number of data units to be accessed to process the read command, thereby improving read performance.

In FIG. 5, a first data unit DU_1 among the plurality of data units DU may include the parameters P11, P12, ... included in the layer L1 among the layers of the artificial intelligence model AI_MDL.

A second data unit DU_2 among the plurality of data units DU may include the parameters P21, P22, … included in the layer L2.

Similarly, a Kth data unit DU_K among the plurality of data units DU may include the parameters PT1, PT2, … included in the layer LT. The value of K may be equal to or greater than T.

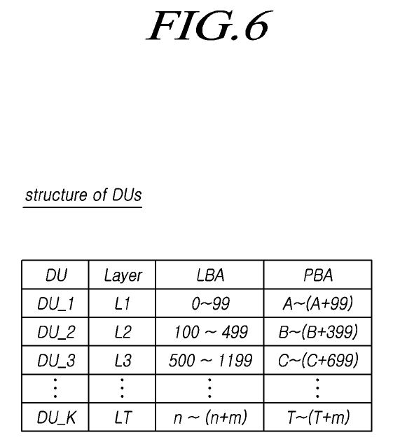

FIG. 6 is a diagram illustrating a structure of the plurality of data units DU, according to an embodiment of the present disclosure.

Referring to FIG. 6, each of K number of data units DU_1, DU_2, DU_3, …, DU_K may correspond to one of the T number of layers L1, L2, L3, …, LT of the artificial intelligence model AI_MDL, where K is a natural number of 2 or more.

Each data unit may correspond to one continuous logical address area. Parameters included in the same data unit are highly likely to be performed simultaneously or at adjacent time frames, and thus, may be configured to be included in one continuous logical address area.

In FIG. 6, the data unit DU_1 corresponds to a logical address area 0 to 99, the data unit DU_2 corresponds to a logical address area 100 to 499, the data unit DU_3 corresponds to a logical address area 500 to 1199, and the data unit DU_K corresponds to a logical address area n to (n+m).

Each data unit may be stored in one continuous physical address area. In order to reduce, when an operation of reading parameters included in the same data unit from the memory 110 is executed, the overhead required in the process of searching for locations where the parameters are stored in the memory 110, the parameters included in the corresponding data unit may be sequentially stored in a continuous physical address area.

In FIG. 6, the data unit DU_1 may be stored in a physical address area A to (A+99), the data unit DU_2 may be stored in a physical address area B to (B+399), the data unit DU_3 may be stored in a physical address area C to (C+699), and the data unit DU_K may be stored in a physical address area T to (T+m).

In the above, an operation in which the storage device 100 determines the structure of the plurality of data units DU has been described.

Hereinbelow, an operation in which the storage device 100 according to embodiments of the present disclosure determines whether to cache each of the plurality of data units DU in the cache CACHE will be described.

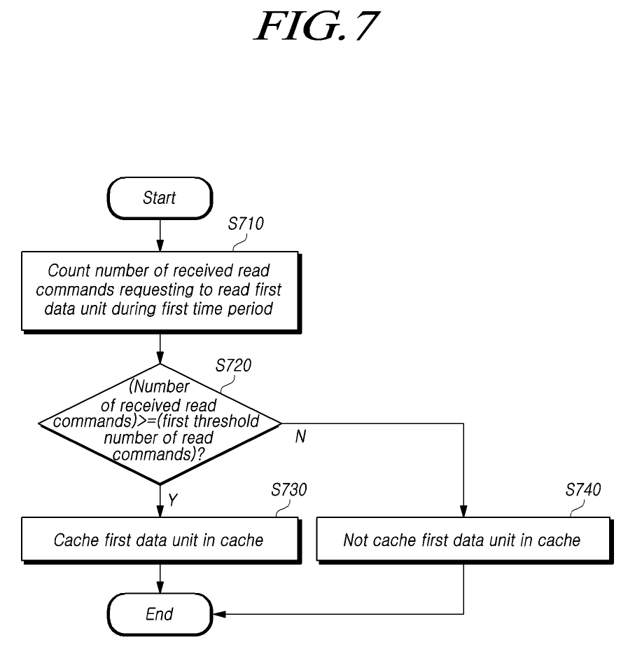

FIG. 7 is a flowchart for describing an operation of the storage device 100 that determines whether to cache the first data unit DU_1 in the cache CACHE, according to an embodiment of the present disclosure.

Referring to FIG. 7, the controller 120 of the storage device 100 may count the number of read commands that are received, during a predetermined first time period, from the outside (e.g., the host HOST) of the storage device 100 and request to read the first data unit DU_1 (S710).

The controller 120 determines whether the number of received read commands is equal to or greater than a first threshold number of read commands (S720). The first threshold number of read commands may be a preset value.

The first threshold number of read commands may be determined in various ways. For example, the first threshold number of read commands may be a preset value. For another example, the first threshold number of read commands may be determined based on the average cache hit rate of the cache CACHE during a predetermined time period. The controller 120 may determine the first threshold number of read commands as a value proportional to the average cache hit rate.

When the number of received read commands is equal to or greater than the first threshold number of read commands (i.e., ‘Y’ in S720), the controller 120 may determine to cache the first data unit DU_1 in the cache CACHE (S730). This is because the first data unit DU_1 is highly likely to be read and thus, when the first data unit DU_1 is cached in the cache CACHE, read performance is highly likely to be improved.

On the other hand, when the number of received read commands is less than the first threshold number of read commands (i.e., ‘N’ in S720), the controller 120 may determine not to cache the first data unit DU_1 in the cache CACHE (S740).

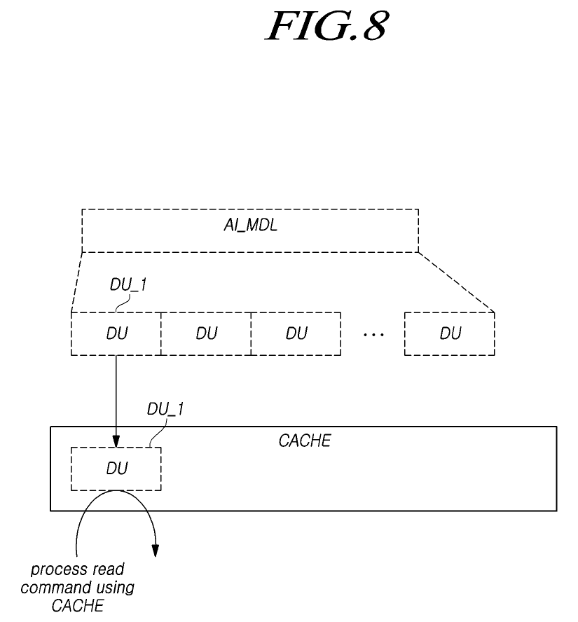

FIG. 8 is a diagram for describing an operation of the storage device 100 that caches a data unit in the cache CACHE, according to an embodiment of the present disclosure.

Referring to FIG. 8, the controller 120 of the storage device 100 may cache the first data unit DU_1 among the plurality of data units DU in the cache CACHE. The entire first data unit DU_1 may be cached in the cache CACHE.

In order to cache the first data unit DU_1 in the cache CACHE, the controller 120 may perform an operation of internally reading the first data unit DU_1.

Thereafter, when processing a read command for the first data unit DU_1, the controller 120 may access the first data unit DU_1 cached in the cache CACHE instead of accessing the memory 110. Through this, the controller 120 may process the read command for the first data unit DU_1 more quickly, thereby improving read performance.

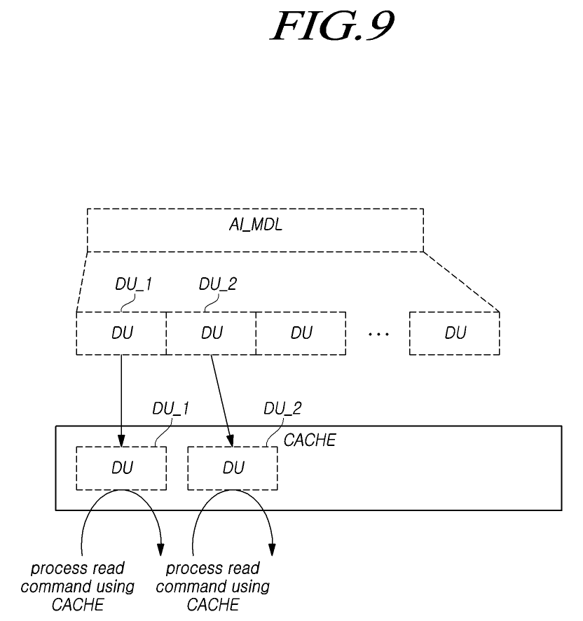

FIG. 9 is a diagram for describing an operation of the storage device 100 that caches data units in the cache CACHE, according to an embodiment of the present disclosure.

Referring to FIG. 9, the controller 120 of the storage device 100 may cache the first data unit DU_1 and the second data unit DU_2 in the cache CACHE. The controller 120 may independently determine whether to cache the first data unit DU_1 in the cache CACHE and whether to cache the second data unit DU_2 in the cache CACHE.

When the first data unit DU_1 is cached in the cache CACHE, the controller 120 may access the first data unit DU_1 cached in the cache CACHE when processing a read command for the first data unit DU_1.

Similarly, when the second data unit DU_2 is cached in the cache CACHE, the controller 120 may access the second data unit DU_2 cached in the cache CACHE when processing a read command for the second data unit DU_2.

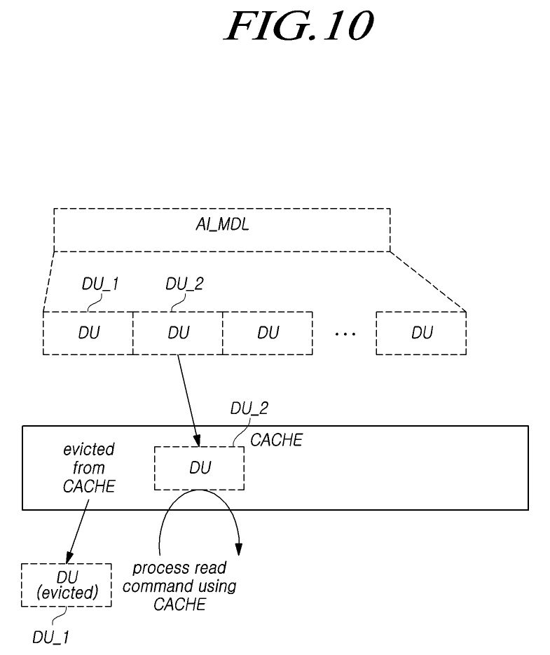

A data unit cached in the cache CACHE may be evicted from the cache CACHE later. Because the size of the cache CACHE is finite, in order to secure a space for caching another data unit in the cache CACHE, a data unit previously cached in the cache CACHE needs to be evicted. This will be described below in detail with reference to FIG. 10.

FIG. 10 is a diagram for describing an operation of the storage device 100 that evicts a data unit from the cache CACHE, according to an embodiment of the present disclosure.

Referring to FIG. 10, the controller 120 of the storage device 100 may evict the first data unit DU_1 cached in the cache CACHE from the cache CACHE. After the first data unit DU_1 is evicted from the cache CACHE, when processing a read command for the first data unit DU_1, the controller 120 may read the first data unit DU_1 from the memory 110.

In embodiments of the present disclosure, the controller 120 may evict the first data unit DU_1 from the cache CACHE when a specific condition is satisfied. Through this, the controller 120 may secure a free space necessary for caching another data unit in the cache CACHE.

For example, when the number of times the first data unit DU_1 cached in the cache CACHE is accessed during a predetermined second time period is less than a threshold number of accesses, the controller 120 may evict the first data unit DU_1 cached in the cache CACHE from the cache CACHE.

In another embodiment, when the number of read commands for reading the first data unit DU_1 among M number of read commands received from the outside (e.g., the host HOST) of the storage device 100 is less than a second threshold number of read commands, the controller 120 may evict the first data unit DU_1 cached in the cache CACHE from the cache CACHE, where M is a natural number.

In another embodiment, when the cache hit rate of the first data unit DU_1 among data units cached in the cache CACHE is the lowest, the controller 120 may evict the first data unit DU_1 cached in the cache CACHE from the cache CACHE.

In still another embodiment, when a time point at which the first data unit DU_1 is cached in the cache CACHE is the oldest among data units cached in the cache CACHE, the controller 120 may evict the first data unit DU_1 cached in the cache CACHE from the cache CACHE.

Regardless of whether the first data unit DU_1 is evicted from the cache CACHE, the second data unit DU_2 may remain cached in the cache CACHE. This is because whether the first data unit DU_1 is cached in the cache CACHE and whether the second data unit DU_2 is cached in the cache CACHE are determined independently.

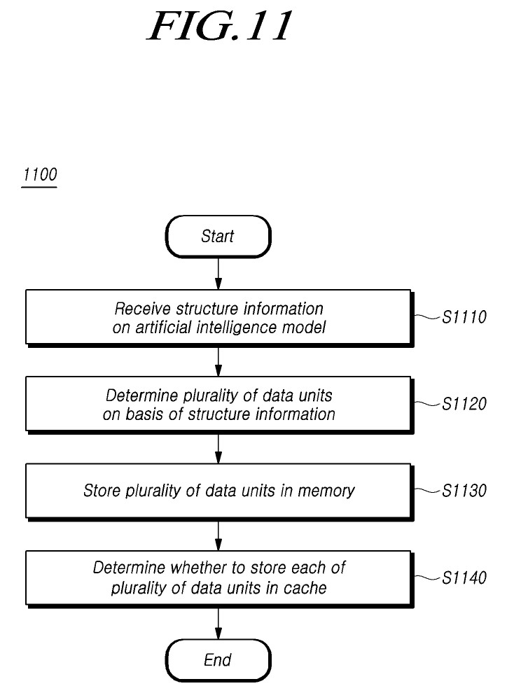

FIG. 11 is a flowchart for describing a method of operating the storage device 100 according to an embodiment of the present disclosure.

Referring to FIG. 11, a method 1100 of operating the storage device 100 may include operation S1110 of receiving structure information STR_INFO on an artificial intelligence model AI_MDL from the outside of the storage device 100.

For example, the structure information STR_INFO may include at least one of the number NUM_PROC of processors that access the artificial intelligence model AI_MDL in parallel, the number NUM_PARAM of parameters of the artificial intelligence model AI_MDL, the size PARAM_SIZE of each parameter of the artificial intelligence model AI_MDL, and layer information LAYER_INFO of the artificial intelligence model AI_MDL.

The method 1100 of operating the storage device 100 may include operation S1120 of determining a plurality of data units DU based on the structure information STR_INFO received in the operation S1110. Each of the plurality of data units DU may include at least one of parameters P of the artificial intelligence model AI_MDL.

For example, a first data unit DU_1 among the plurality of data units DU may include parameters included in a first layer among the layers of the artificial intelligence model AI_MDL.

The first data unit DU_1 may correspond to one continuous logical address area. The first data unit DU_1 may be stored in one continuous physical address area of the memory 110.

The method 1100 of operating the storage device 100 may include operation S1130 of storing the plurality of data units DU in the memory 110.

The method 1100 of operating the storage device 100 may include operation S1140 of determining whether to cache each of the plurality of data units DU in the cache CACHE.

For example, when the number of read commands that are received, during a predetermined first time period, from the outside of the storage device 100 and request to read the first data unit DU_1 among the plurality of data units DU is equal to or greater than a first threshold number of read commands, the operation S1140 may determine to cache the first data unit DU_1 in the cache CACHE.

For example, the method 1100 of operating the storage device 100 may further include evicting, when the number of times the first data unit DU_1 cached in the cache CACHE is accessed during a predetermined second time period is less than a threshold number of accesses, the first data unit DU_1 cached in the cache CACHE from the cache CACHE.

In another embodiment, the method 1100 of operating the storage device 100 may further include evicting, when the number of read commands for reading the first data unit DU_1 among M number of read commands received from the outside of the storage device 100 is less than a second threshold number of read commands, the first data unit DU_1 cached in the cache CACHE from the cache CACHE, where M is a natural number.

Although embodiments of the present disclosure have been described for illustrative purposes, those skilled in the art will appreciate that various modifications, additions and substitutions are possible, without departing from the scope and spirit of the present disclosure. Therefore, the embodiments disclosed above and in the accompanying drawings should be considered in a descriptive sense only and not for limiting the technological scope. The technological scope of the present disclosure is not limited by the embodiments and the accompanying drawings. The spirit and scope of the present disclosure should be interpreted in connection with the appended claims and encompass all equivalents falling within the scope of the appended claims. Furthermore, the embodiments may be combin ed to form additional embodiments.

What is claimed is:

1. A storage device comprising:
a memory configured to store a plurality of data units, each data unit including at least one of parameters of an artificial intelligence model; and
a controller configured to externally receive structure information on the artificial intelligence model, determine the plurality of data units based on the structure information, and determine whether to cache each of the plurality of data units in a cache.

2. The storage device according to claim 1, wherein the structure information includes at least one of:
a number of processors that access the artificial intelligence model in parallel;
a number of parameters of the artificial intelligence model;
a size of each parameter of the artificial intelligence model; and
layer information of the artificial intelligence model.

3. The storage device according to claim 1, wherein a first data unit among the plurality of data units includes parameters that are included in a first layer among layers of the artificial intelligence model.

4. The storage device according to claim 3, wherein the first data unit corresponds to one continuous logical address area.

5. The storage device according to claim 4, wherein the first data unit is stored in one continuous physical address area of the memory.

6. The storage device according to claim 1, wherein, when a number of read commands that are externally received during a predetermined first time period and that request to read the first data unit among the plurality of data units is equal to or greater than a first threshold number of read commands, the controller is configured to determine to cache the first data unit in the cache.

7. The storage device according to claim 6, wherein, when a number of times the first data unit cached in the cache is accessed during a predetermined second time period is less than a threshold number of accesses, the controller is configured to evict the first data unit cached in the cache from the cache.

8. The storage device according to claim 6, wherein, when a number of read commands for reading the first data unit among M number of read commands externally received is less than a second threshold number of read commands, the controller is configured to evict the first data unit cached in the cache from the cache, where M is a natural number.

9. A method of operating a storage device including a memory, the method comprising:
externally receiving structure information on an artificial intelligence model;
determining a plurality of data units based on the structure information, each data unit including at least one of parameters of the artificial intelligence model;
storing the plurality of data units in the memory; and
determining whether to cache each of the plurality of data units in a cache.

10. The method according to claim 9, wherein the structure information includes at least one of:
a number of processors that access the artificial intelligence model in parallel;
a number of parameters of the artificial intelligence model;
a size of each parameter of the artificial intelligence model; and layer information of the artificial intelligence model.

11. The method according to claim 9, wherein a first data unit among the plurality of data units includes parameters that are included in a first layer among layers of the artificial intelligence model.

12. The method according to claim 11, wherein the first data unit corresponds to one continuous logical address area.

13. The method according to claim 12, wherein the first data unit is stored in one continuous physical address area of the memory.

14. The method according to claim 9, wherein, in response to a determination that a number of read commands which are externally received during a predetermined first time period and which request to read the first data unit among the plurality of data units is equal to or greater than a first threshold number of read commands, the determining whether to cache includes determining to cache the first data unit in the cache.

15. The method according to claim 14, further comprising
evicting, in response to a determination that a number of times the first data unit cached in the cache is accessed during a predetermined second time period is less than a threshold number of accesses, the first data unit cached in the cache from the cache.

16. The method according to claim 14, further comprising
evicting the first data unit cached in the cache from the cache, in response to a determination that the number of read commands for reading the first data unit among M number of read commands externally received is less than a second threshold number of read commands, where M is a natural number.
